(19) United States
(12) Patent Application Publication
(10) Pub. No.: US 2006/0091983 A1
(43) Pub. Date: May 4, 2006

(54) Electrostatic microswitch for low-voltage-actuation component

(76) Inventor: Philippe Robert, Grenoble (FR)

Correspondence Address: Thelen Reid & Priest, P.O Box 640640, San Jose, CA, 95164-0640, US

(21) Appl. No.: 10/536,585

(22) PCT Filed: Nov. 27, 2003
(86) PCT No.: PCT/FR03/50137

§ 371 Date: May 26, 2005

(30) Foreign Application Priority Data
Nov. 28, 2002 (FR) 02 14946

(51) Int. Cl. H01H 51/22

(52) U.S. Cl. 335/78

(57) ABSTRACT

The invention relates to an electrostatic microswitch which is intended to connect electrically two strip conductors which are disposed on an insulating support (21), the two strip conductors are connected electrically by conducting means (38) which are provided in the central part of deformable means (28) which can be deformed in relation to the support under the effect of an electrostatic force generated by control electrodes (25, 48; 26, 58). The control electrodes are distributed facing one another on the deformable means and the support, such as to form capacitive means around the aforementioned conducting means. The control electrodes are associated with insulating stop elements (35, 36) which are provided in order to prevent a short circuit between electrodes of the capacitive means during the deformation of the deformable means. The distance between the deformable means and the ends of the strip conductors is less than or equal to the distance between the insulating stop elements associated with the control electrodes and the control electrodes located opposite.

### DESCRIPTION

1 Technical Field

The invention relates to an electrostatic microswitch with high operational reliability adapted to low actuating voltage components. The term microswitch refers to the micro-relays, the MEMS (Micro-Electro-Mechanical-System) type actuators and the high frequency actuators.

2. Background of the Invention

The article “RF MEMS from a device perspective” by J. Jason Yao, published in J. Micromech. Microeng. 10 (2000), pages R9 to R38, summarises recent developments made in the field of MEMS for high frequency applications.

The following specifications are required of the high frequency or RF components for mobile telephony:

power supply voltage of less than 5 V,

insulation of over 30 dB,

insertion loss of less than 0.3 dB,

reliability for a number of cycles over 10⁹,

dimensions of less than 0.05 mm².

The microswitches are widely used in the field of communications: for signal routing, impedance tuning networks, amplifier gain adjusting, and so on. With regard to the frequency bands of the signals to be switched, these frequencies consist of between a few MHz and several dozen GHz.

Usually, for these RF circuits, micro-electronic switches are used, as their production cost is low and as they enable integration with the circuit electronics. In terms of performance, these components are, however, relatively limited. Hence, FET-type silicon switches can switch high-power signals at low frequencies but not at high frequencies. The MESFET-type GaAs switches or the PIN diodes operate well at high frequencies but only for low-level signals. Finally, generally speaking, beyond 1 GHz, all of the microelectronic switches show a high insertion loss (usually around 1 to 2 dB) during the conducting state and relatively low insulation during the non-conducting state (−20 to −25 dB). The replacement of conventional components with MEMS microswitches is consequently promising for this type of application.

On account of their design and operating principle, the MEMS switches have the following characteristics:

low insertion loss (typically less than 0.3 dB),

high insulation from Mhz to millimeters (typically greater than −30 dB),

low consumption,

no non-linearity of response.

There are two types of contact for these MEMS microswitches.

One of these contact types is the ohmic contact switch described in the abovementioned article “RF MEMS from a device perspective” by J. Jason Yao and in the article “A Surface Micromachined Miniature Switch For Telecommunications Applications with Signal Frequencies From DC up to 4 GHz” by J. Jason Yao and M. Franck Chang, published in the Transducers '95 review, Eurosensors IX, pages 384 to 387. In this type of contact, the two RF strips are brought into contact by means of a short-circuit (metal to metal contact). This type of contact is just as adapted to DC signals as it is to high frequency signals (over 10 GHz).

The other type of contact is the capacitive switch described in the abovementioned article “RF MEMS from a device perspective” by J. Jason Yao and in the article “Finite Ground Coplanar Waveguide Shunt MEMS Switches for Switched Line Phase Shifters” by George E. Ponchak et al., published in the 30th European Microwave Conference, Paris 2000, pages 252 to 254. In this type of contact, a layer of air is electromechanically adapted to obtain a capacity variation between the conducting state and the non-conducting state. This type of contact is particularly well adapted to high frequencies (over 10 GHz) but is inadequate at low frequencies.

In the state of the art, there are two main actuating principles for MEMS switches: thermally actuated switches and electrostatically actuated switches.

Thermally actuated switches have the advantage of being of low actuating voltage. On the other hand, they have the following disadvantages: Excessive consumption (especially in the case of mobile telephony applications), a low switching rate (due to thermal inertia) and technology that is often complicated.

Electrostatically actuated switches have the advantage of a high switching rate and relatively straightforward technology. On the other hand, they are disadvantaged by problems resulting from their low reliability coefficient. This point particularly critical in the case of electrostatic microswitches with low actuating voltage (structural binding possible)

The electrostatic actuating switch binding issue is crucial. This issue is deliberated in the abovementioned article by George E. Ponchak et al. and in the article “Communications Applications of Microelectromechanical Systems” by Clark T.-C. Nguyen published in Proceedings, 1998 Sensors Expo, San Jose, Calif., 19 to 21 May 1998, pages 447 to 455.

The state of the art electrostatic microswitches have a mobile actuating electrode isolated from the fixed electrode by means of a dielectric layer to avoid short-circuits during microswitch switchover. This dielectric layer, included in the mobile actuating capacity is never perfect. It has faults which give rise to trapping of charges in the layer. These charges that accumulate in the dielectric may eventually lead to a fault in the component (binding of the beam or the need for increasing amounts of actuating voltage during the course of the switching cycles).

This phenomenon is heightened in the case of microswitches of low actuating voltage, whereby to obtain the switching voltages generally required (usually greater than or equal to 5 volts), the designers use mobile structures with low mechanical stiffness, which is to say an elastic restoring force which proves to be insufficient with regard to the spurious electrostatic forces brought about by this trapping of charges phenomenon, and which very often leads to the binding of microswitches after between 10⁴ and 10⁵ cycles, or well below the generally required specifications (more than 10⁹ cycles).

A simple way in which to avoid charge trapping would be to use a metal beam. There would consequently be a high risk of a short circuit in this beam on the actuating electrode, namely in the case of microswitches with low switchover voltage that are of low mechanical stiffness. To solve this short circuit problem, we could consider fitting small dielectric stop elements on the actuating electrodes, as the charge trapping restricted to the stop elements should not disrupt operation of the microswitch. Herein, the problem lies in the high risk of the beam coming into contact with the stop element, preventing contact with the strip conductors to be connected.

### SUMMARY OF THE INVENTION

The present invention has been designed to remedy the inconveniences manifested with the prior devices of the art.

The purpose is to produce an electrostatic microswitch which is intended to connect electrically to at least two strip conductors which are placed on an insulating support, the two strip conductors are connected electrically by conducting means which are provided in the central part of deformable means which can be deformed in relation to the support, under the impact of an electrostatic force generated by control electrodes distributed facing one another on the deformable means and the support, such as to form capacitive means around the aforementioned conducting means, said conductive means performing the electrical connection between the two strip conductors when the deformable means are deformed until they are brought into contact with the ends of the strip conductors, characterized in that:

the one or several control electrode(s) on the support or the one or several control electrode(s) on the deformable means is or are associated with insulating stop elements provided in order to prevent a short-circuit between electrodes of said capacitive means during deformation of the deformable means,

the distance between the deformable means and the ends of the strip conductors is less than or equal to the distance between the insulating stop elements associated with the one or several control electrode(s) of the one or several control electrode(s) located opposite.

The deformable means may be selected amongst a membrane and a beam.

According to a first fabrication alternative, the deformable means are made of a conductive material and constitute a control electrode and the conductive means.

According to a second fabrication alternative, the deformable means are made of an insulating material and support the conducting parts to constitute one or several control electrode(s) and a conductive stud to constitute said conductive means.

Each end of the strip conductor end may be formed on a projection of the support.

The conductive means may be protruding in relation to the deformable means.

The insulating stop elements may be pads made of an insulating material supported by one or several control electrode(s)

The insulating stop elements may be protruding parts of the one or several control electrode(s) located opposite insulating parts located in or close to one or several control electrode(s) facing one another.

If the microswitch is of ohmic contact type, the conductive means can directly electrically contact the strip conductor ends.

If the microswitch is of capacitive contact type, an insulating material layer is interposed between the conductive means and the strip conductor ends.

### BRIEF DESCRIPTION OF THE DRAWINGS

The overall view of the invention will become more clear and other aspects and advantages of the invention will become apparent from the following description, given by way of a non-limitative example, with the accompanying drawings in which:

FIGS. 1 and 2 are sectional views, longitudinal and from above, respectively, of a first alternative of the microswitch described in the invention,

FIG. 3 is a longitudinal, cross-sectional view of a second alternative of the microswitch as described in the invention,

FIG. 4 is a longitudinal, cross-sectional view of a third alternative of the microswitch as described in the invention,

FIG. 5 is a longitudinal, cross-sectional view of a fourth alternative of the microswitch as described in the invention,

FIG. 6 is a longitudinal, cross-sectional view of a fifth alternative of the microswitch as described in the invention,

FIGS. 7A to 7H are longitudinal, cross-sectional views of a fabrication method of the microswitch according to the fifth alternative of the invention,

### DETAILED DESCRIPTION OF EMBODIMENTS OF THE INVENTION

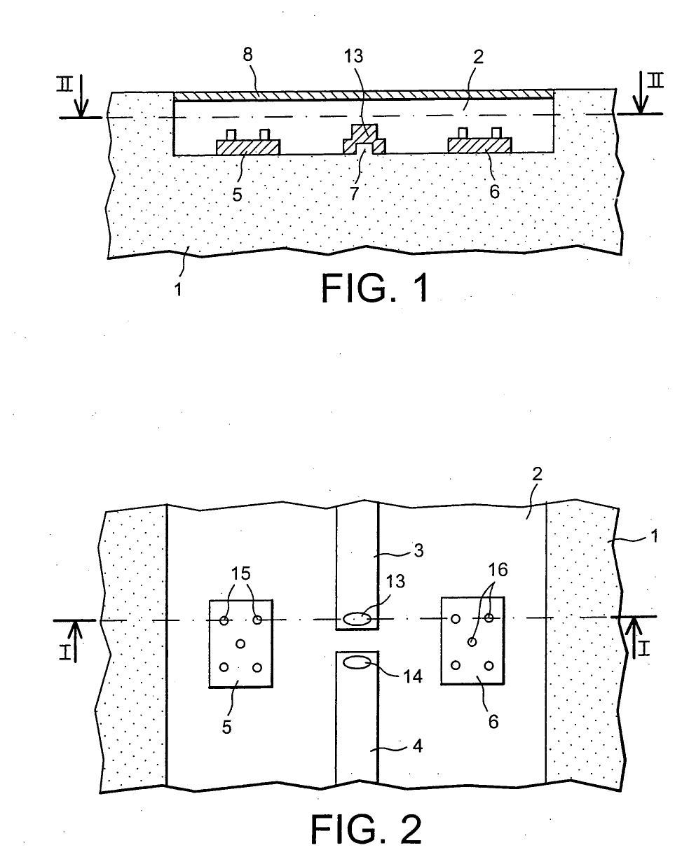

FIGS. 1 and 2 are sectional views, longitudinal and from above, respectively, of a first alternative of the microswitch described in the invention. FIG. 1 is a view of section I-I of FIG. 2 and FIG. 2 is a view of section II-II of FIG. 1.

The microswitch is made in an insulating part of a substrate 1. A recess 2 has been made in one of the faces of substrate 1. The central part of the bottom of the recess supports two electrically connected strip conductors 3 and 4. The bottom of the recess also supports lower control electrodes 5 and 6 located on each side of the strip conductors 3 and 4, and of which the electrical connections have not been shown.

The ends 13 and 14 of the strip conductors 3 and 4, are located opposite one another. They are formed on a projection on the bottom of the recess. Only projection 7 is shown in FIG. 1.

The lower control electrodes 5 and 6 support pads made of an insulating material, 15 and 16 respectively. These insulating pads are small in comparison to the size of the electrodes.

A metal beam 8, embedded at both of its ends, is suspended above recess 2. It is located opposite the lower control electrodes 5 and 6 and the ends 13 and 14 of the strip conductors 3 and 4. The conductive beam 8 constitutes the upper control electrodes as well as an ohmic contact stud for strip conductor ends 13 and 14.

The distance between insulating pads 15 or 16 of a same lower control electrode 5 or 6 is short enough to avoid any risk of deformation of the beam 8 that may cause a short circuit in the control electrodes, that is to say between the conductive beam 8 and the electrode 5 on one hand, and between the conductive beam 8 and electrode 6 on the other hand. The maximum distance between two insulating pads of one same lower control electrode is established according to the height of the insulating pads, the rigidity of the beam and the control voltage.

The distance between the conductive beam 8 of the ends 13 and 14 of the strip conductors 3 and 4 is less than or equal to the distance between the insulating pads 15 and 16 of the conductive beam 8.

Under the effect of an appropriate control voltage applied between the conductive beam 8 and the electrodes 5 and 6, the beam 8 flexes until it comes into contact with the strip conductor ends.

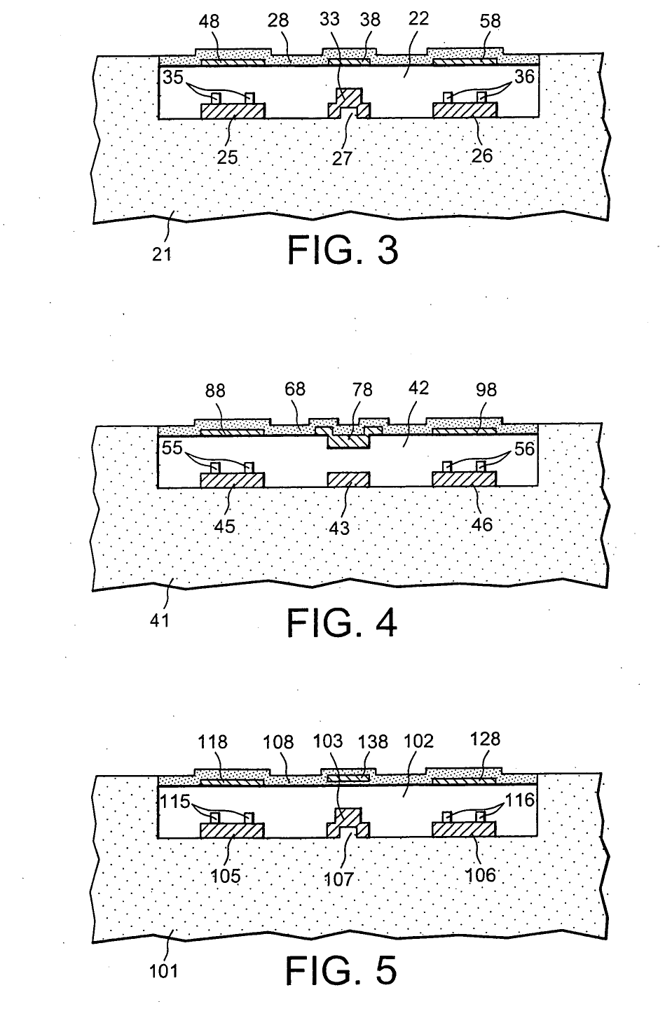

FIG. 3 is a longitudinal, cross-sectional view of a second alternative of the microswitch as described in the invention.

Shown in this figure are the insulating part of a substrate 21, a recess 22, lower control electrodes 25 and 26 fitted with insulating pads 35 and 36 respectively, one of the projections 27 and one of the strip conductor ends 33. These elements are similar to the same elements of the first alternative of the microswitch as described in the invention.

The second alternative of the microswitch according to the invention differs from the first alternative in that the nature of the beam 28 is made of an insulating material. The face of the beam 28 turned towards the recess 22 supports a conductive stud 38 located opposite the strip conductor ends and the upper control electrodes 48 and 58 respectively associated with the lower control electrodes 25 and 26.

Under the effect of an appropriate control voltage applied between the upper control electrodes 48 and 58 and the lower control electrodes 25 and 26, the beam 28 flexes until the conductive stud 38 comes into contact with the strip conductor ends.

The distance between the conductive stud 38 and the strip conductor ends is less than or equal to the distance between the insulating pads 35 and 36 and the respective electrodes 48 and 58.

FIG. 4 is a longitudinal, cross-sectional view of a third alternative of the microswitch as described in the invention.

In this figure, in relation to FIG. 3, we can see the insulating part of a substrate 41, a recess 42 and lower control electrodes 45 and 46 fitted with insulating pads 55 and 56 respectively. Also shown is a beam 68 made of an insulating material, of which the face turned towards the recess supports a conductive stud 78 located opposite strip conductor ends and upper control electrodes 88 and 98 respectively associated with the lower control electrodes 45 and 46.

The third alternative of the microswitch according to the invention differs from the second alternative in that the strip conductor ends (only end 43 is shown) are not formed on the projections but on the bottom of the recess. However, the conductive stud 78 is protruding in relation to the face of the beam turned towards the recess such that the distance between the conductive stud 78 and the strip conductor ends is less than or equal to the distance between the insulating pad 55 or 56 of the upper control electrode 88 or 98.

Under the effect of an appropriate control voltage applied between the upper control electrodes 88 and 98 and the lower control electrodes 45 and 46, the beam 68 flexes until the conductive stud 78 comes into contact with the strip conductor ends.

FIG. 5 is a longitudinal, cross-sectional view of a fourth alternative of the microswitch as described in the invention.

In this figure, in relation to FIG. 3, we can see the insulating part of a substrate 101, a recess 102, lower control electrodes 105 and 106 fitted with insulating pads 115 and 116 respectively, one of the projections 107 and one of the strip conductor ends 103. Also shown is a beam 108 made of an insulating material, of which the face turned towards the recess supports upper control electrodes 118 and 128 respectively associated with the lower control electrodes 105 and 106.

The fourth alternative of the microswitch according to the invention differs from the second alternative in that the insulating beam 108 integrates the conductive stud 138. Thereby, a thin insulating material layer is interposed between the conductive stud 138 and the strip conductor ends, the microswitch being of a capacitive type.

Under the effect of an appropriate control voltage applied between the upper control electrodes 118 and 128 and the lower control electrodes 105 and 106, the beam 108 flexes until it comes into mechanical contact with the strip conductor ends, thereby establishing a capacitive type connection between the strip conductors.

The distance between the beam 108 and the strip conductor ends is less than or equal to the distance between the insulating pads 115 and 116 of the respective electrodes 118 and 128.

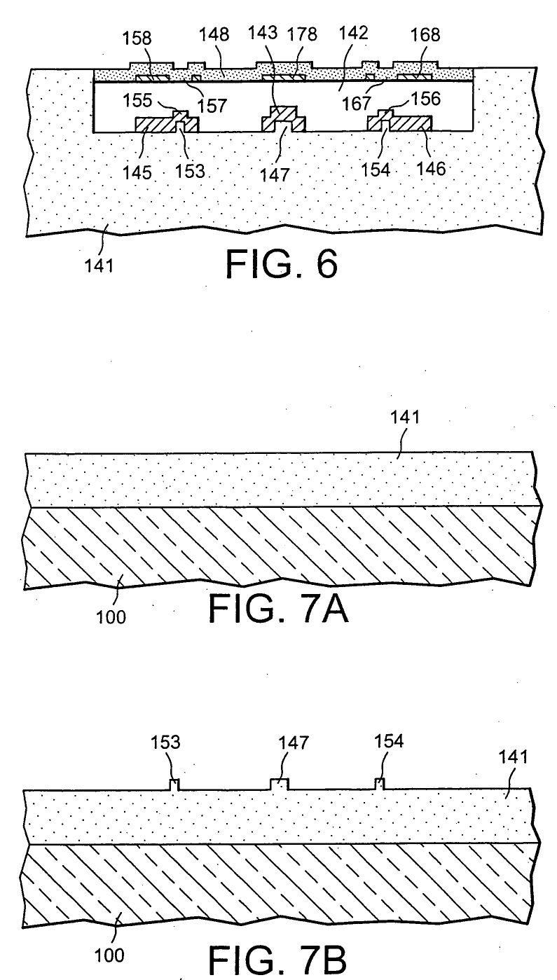

FIG. 6 is a longitudinal, cross-sectional view of a fifth alternative of the microswitch as described in the invention.

In this figure, in relation to FIG. 3, we can see the insulating part of a substrate 141, a recess 142, lower control electrodes 145 and 146 and one of the strip conductor ends 143 formed on a projection 147. Also shown is a beam 148 made of an insulating material, of which the face turned towards the recess supports a central conductive stud 178 and upper control electrodes 158 and 168 respectively associated with electrodes 145 and 146.

The fifth alternative of the microswitch according to the invention differs from the second alternative in that the lower control electrodes 145 and 146 are fitted with pads 155 and 156 respectively, made of the same material as that of the electrodes. Pads 155 and 156 are formed as a result of the presence of projections 153 and 154 respectively, on the bottom of the recess. Pads 155 and 156 are distributed across electrodes 145 and 146 according to the same criteria as the insulating pad of the prior alternatives.

Opposite pads 155 and 156, the upper control electrodes 158 and 168 are pierced with openings filled in with dielectric material forming insulating patches 157 and 167 so as to prevent any short circuits from occurring with these electrodes.

The distance between the conductive stud 178 and the strip conductor ends is less than or equal to the distance between the pads 155 and 156 of the respective insulating patches 157 and 167.

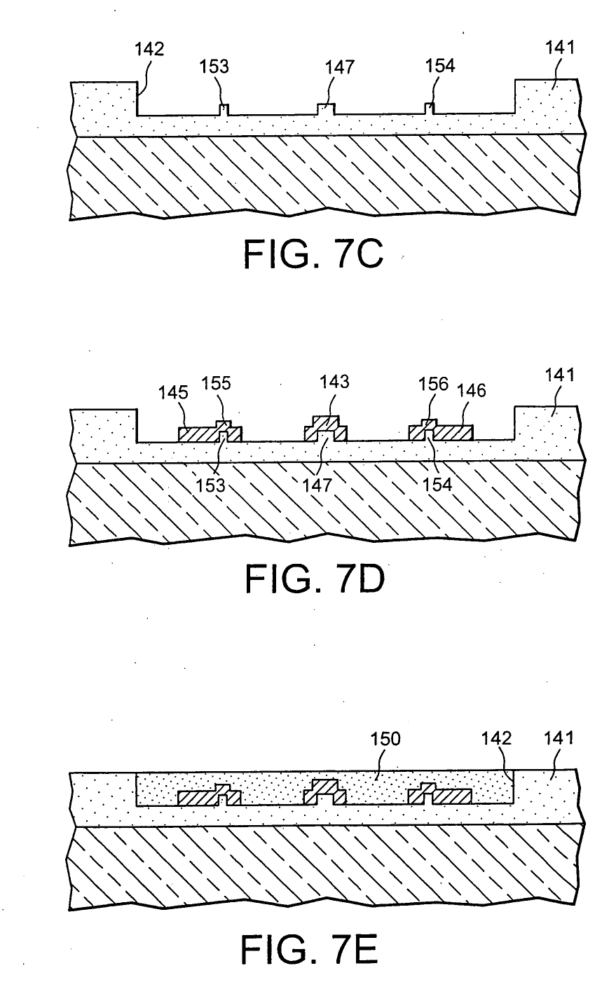

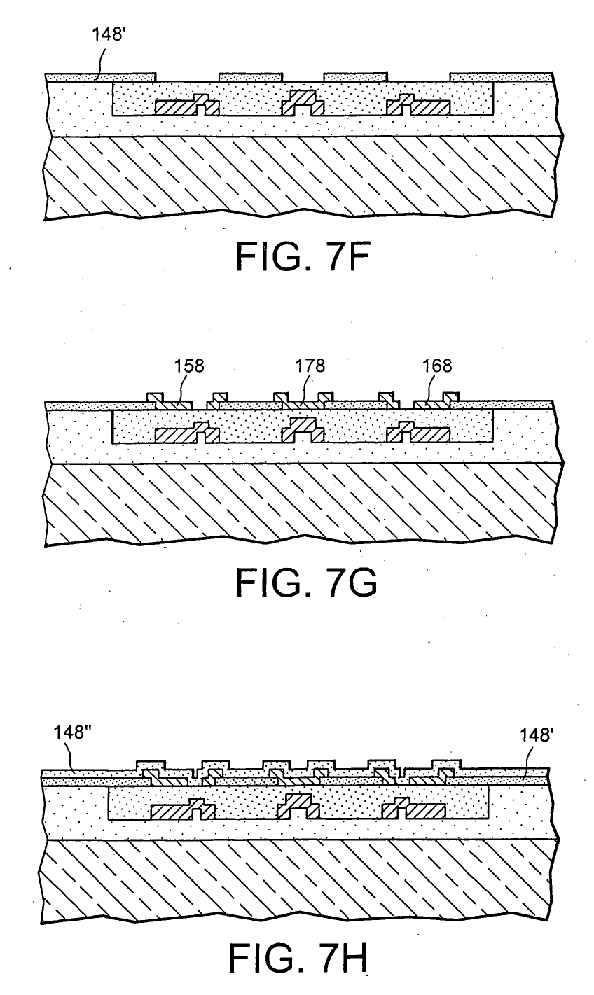

FIGS. 7A to 7H are longitudinal, cross-sectional views of a fabrication method of the microswitch according to the fifth fabrication alternative.

FIG. 7A shows a silicon substrate 100 covered with a dielectric layer 141 formed on substrate 100. Layer 141 may be 2.4 μm in thickness and consist of Si₃N₄ or SiO₂.

Layer 141 is micromachined by lithographic etching to form a central projection 147 on its surface in between the other projections 153 and 154 (see FIG. 7B) . Only one projection 153 and one projection 154 are shown. The projections may be 0.3 μm in height, thereby reducing the thickness of the layer 141 to 2.1 μm.

A layer 141 with projections is also lithographically micro-machined to create a recess 142 as shown in FIG. 7C. Projections 147, 153 and 154 are transferred onto the bottom of the recess 142. The recess may be 0.5 μm in depth. In this same lithographic etching phase, grooves (not shown) are formed to accommodate the electrical connections for the future lower control electrodes, the strip conductors and for the ground plane.

The conductive strips and the lower control electrodes are then fabricated by means of a layer of metal (for example, gold, copper or aluminium), followed by a lithographic etching. FIG. 7D shows one of the ends 143 of a strip conductor, formed on the projection 147 and the lower control electrodes 145 and 146. The electrode 145 includes pads 155 reproducing the form of the projections 153. The electrode 146 includes pads 156 reproducing the form of the projections 154. The thickness of the end 143 may be 1.2 μm. The thickness of the lower control electrodes may be 0.9 μm.

A sacrifice layer 150, of polyimide for example, is then deposited in recess 142. The layer 150 is planarised until it reaches the upper face of the layer 141 as shown in FIG. 7E.

A first dielectric layer 148′, of Si₃N₄ or SiO₂ for example, is then deposited on the planarised surface of the previous structure (see FIG. 7F). This first dielectric layer may be 0.15 μm in thickness. The appropriate areas of this layer are lithographically etched to accommodate the upper control electrodes and the conductive stud.

A metal layer (for example gold on an adhesion layer surface of Cr, copper or aluminium) is then deposited on the first dielectric layer 148′. By lithographically etching this layer, the upper control electrodes 158 and 168 and the conductive stud 178 are formed. This is shown in FIG. 7G. The electrical connections with these conductive elements are made during the course of the same procedure.

A second dielectric layer 148″ is deposited on the previously obtained structure as shown in FIG. 7H. By lithographic etching, openings (not shown) are formed in the thickness of the two dielectric layers 148′ and 148″ to reveal the sacrifice layer 150 and to recover the contact with the electrodes.

The sacrifice layer is thus eliminated by means of selective etching through the previously formed openings. The structure shown in FIG. 6 is thereby obtained, in which the insulating part of the beam is shown under the general reference 148.

The invention limits the trapping of charges and hence the bonding effect to very restricted areas (insulating stop elements). It prevents any risk of short circuits between the control electrodes owing to the presence of these insulating stop elements. It ensures good connection of the microswitch as a result of the distance between the deformable means and the ends of the strip conductors being less than or equal to the distance between the insulating stop elements associated with the control electrodes and the control electrodes located opposite.

The microswitch switchover speed is a function of the viscous damping of the beam (or the membrane). This damping is inversely proportional to the distance (or air gap) between the beam and the strip conductors and lower control electrode, and also inversely proportional to the surfaces opposite. Hence, the more the beam flexes and moves closer to the conductors to be switched, the more the damping increases and tends to retain movement. This results in an increase in transit time. In the case of the present invention, the areas in which there is much damping (narrow air gap) are limited to the stop elements (on the actuating electrodes) and to the projections (at contact). The surfaces in question are consequently extremely reduced in comparison to the state of the art MEMS microswitches. The switching time is consequently optimised.

1. An electrostatic microswitch intended to electrically connect at least two electrical strip conductors disposed on an insulating support, the two strip conductors being connected electrically by conducting means provided in the central part of deformable means which can be deformed in relation to the support under the effect of an electrostatic force generated by control electrodes which are distributed facing one another on the deformable means and the support, so as to form capacitive means around said conducting means, said conductive means performing the electrical connection between the two strip conductors when the deformable means are deformed to contact the ends of the strip conductors, wherein:
the control electrode or the control electrodes on the support or the control electrode or control electrodes on the deformable means is or are associated with insulating stop elements provided in order to prevent a short-circuit between electrodes of said capacitive means during the deformation of the deformable means,
the distance between the deformable means and the ends of the strip conductors is less than or equal to the distance between the insulating stop elements associated with a control electrode or control electrodes of the control electrode or the control electrodes facing one another,
the insulating stop elements are protruding parts of the control electrode(s) located opposite insulating parts located in or close to a control electrode or control electrodes facing one another.

2. A microswitch according to claim. 1, wherein the deformable means are selected amongst a membrane and a beam.

3. A microswitch according to claim 1, wherein the deformable means are made of a conductive material and constitute a control electrode and the conductive means.

4. A microswitch according to claim 1, wherein the deformable means are made of an insulating material and support conductive parts to constitute a control electrode or control electrodes and a conductive stud to constitute said conductive means.

5. A microswitch according to claim 1, wherein each strip conductor end is formed on a projection of the support.

6. A microswitch according to claim 1, wherein said conductive means are protruding in relation to the deformable means.

7. A microswitch according to claim 1, wherein the microswitch being of an ohmic contact type, the conductive means can directly electrically contact the strip conductor ends.

8. A microswitch according to claim 1, wherein the microswitch being of a capacitive contact type, an insulating material layer is interposed between the conductive means and the strip conductor ends.
